(19) United States
(12) Patent Application Publication
(10) Pub. No.: US 2016/0094907 A1
(43) Pub. Date: Mar. 31, 2016

(54) EARPHONE DEVICE, ELECTRONIC DEVICE ASSEMBLY AND CONTROL METHOD OF ELECTRONIC DEVICE ASSEMBLY

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YONG-HUI XIAO, Shenzhen (CN); YI-FANG WU, New Taipei (TW); QING-HUA LIU, Shenzhen (CN); GUO-HUI MOU, Shenzhen (CN)

(21) Appl. No.: 14/542,205

(22) Filed: Nov. 14, 2014

(30) Foreign Application Priority Data
Sep. 26, 2014 (CN) 201410501162.3

(51) Int. Cl. H04R 1/10

(52) U.S. Cl. CPC H04R 1/1041

(57) ABSTRACT

An earphone device used to be engaged with an earphone jack of a portable terminal including an earphone plug. The earphone includes two sections, a power supply and a switch coupled with the power supply. A first end of the power supply is coupled with one of the two sections, and a second opposite end of the power supply coupled with another of the two sections. The earphone device is used to send a first electronic signal to the portable terminal when the switch is switched on and send a second electronic signal to the portable terminal when the switch is switched off, which allows the portable terminal to start one of at least two operation modes of the earphone. The disclosure further offers an electronic device assembly with the portable terminal and the earphone device and a control method of the electronic device assembly.

### FIELD

The subject matter herein generally relates to an earphone device, an electronic device assembly and a control method of the electronic device assembly.

### BACKGROUND

Recently, portable terminals have been more widely used due to their mobility with an earphone device. Mobile communication terminals, which allow users to perform a voice communication wirelessly and/or while moving, have been very popular. On the other hand, the mobile communication terminals have various functions as well as an important function for transmission and reception of communication information between users. For example, the related art portable terminals have a digital audio function corresponding to a music file reproduction function, and an image collection function corresponding to a digital camera. Furthermore, the related art portable terminals have supported a function for execution of mobile games, arcade games, and the like.

### BRIEF DESCRIPTION OF THE DRAWINGS

Implementations of the present technology will now be described, by way of example only, with reference to the attached figures.

FIG. 1 is a circuit view of an embodiment of an earphone device and a portable terminal.

FIG. 2 is a diagrammatic view of the user interface of the portable terminal which connecting the earphone device of FIG. 1.

FIG. 3 is a diagrammatic view of the earphone device and the portable terminal of FIG. 1.

FIG. 4 is flowchart of a control method of the portable terminal connecting the earphone device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an earphone device used to be engaged with an earphone jack of a portable terminal comprising an earphone plug. The earphone comprises two sections, a power supply and a switch coupled with the power supply. A first end of the power supply is coupled with one of the two sections, and a second opposite end of the power supply coupled with another of the two sections. The earphone device is used to send a first electronic signal to the portable terminal when the switch is switched on and send a second electronic signal to the portable terminal when the switch is switched off, for allowing the portable terminal to start one of at least two operation modes of the earphone.

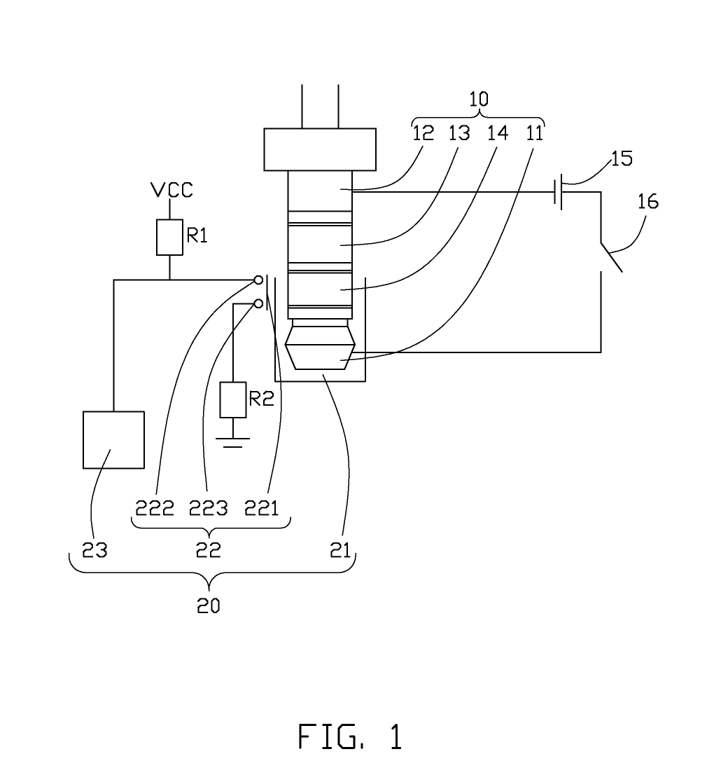

FIG. 1 illustrates an earphone device 100 comprises an earphone plug 10. The earphone plug 10 comprises a first section 11, a second section 12, a third section 13, a fourth section 14, a power supply 15, and a switch 16. In at least one embodiment, the earphone device 100 can be a line control earphone, the first section 11 can be a left channel, the second section 12 can be a ground terminal, the third section 11 can be a microphone, and the fourth section 14 can be a right channel. In another embodiment, the second section 12 can be a microphone, and the fourth section 14 can be a ground terminal.

A negative pole of the power supply 15 is coupled to the second section 12 to be grounded. A first end of the switch 16 is coupled to a positive pole of the power supply 15, and a second opposite end of the switch 16 is coupled to the first section 11. In at least one embodiment, the second end of the switch 16 can be coupled to the third section 13 or the fourth section 14, and the power supply 15 can be grounded via another ground terminal.

The earphone device 100 can be coupled with a portable terminal 20. The portable terminal 20 comprises an earphone jack 21, a switching module 22 adjacent to the earphone jack 21, and a processing module 23. The switching module 22 comprises an elastic piece 221, a first coupling end 222 and a second coupling end 223. The first coupling end 221 is coupled to the processing module 23 and further coupled to a portable terminal power supply VCC via a first resistor R1. The second coupling end 223 is grounded via a second resistor R2. In at least one embodiment, the processing module 23 is a central processing unit (CPU) in the portable terminal 20.

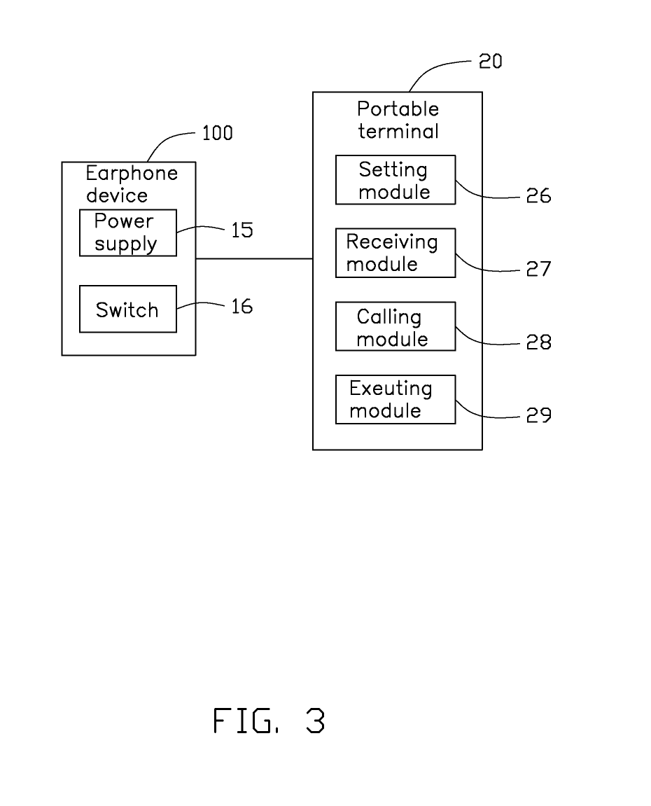

Referring to FIG. 3, the portable terminal 20 comprises a setting module 26, a receiving module 27, a calling module 28, and an executing module 29. The setting module 26 is configured to set functions, for example, a short press to open a photograph application; two short press to open a video application; three short press to open a flashlight application; a long press to open a telephone application. The switch 16 can be powered on to generate a high level signal and powered off to generate a low level signal, so that the earphone device 10 can send different signals to the receiving module 27 according to a switching time between the high level signal and the low level signal generated by the switch 16. The calling module 28 is configured to judge the operation of the switch 16 according to the different signals and call a corresponding application. The executing module 29 is configured to execute the corresponding application according to an indication of the calling module 28. For example, a short press to open a photograph application; two short press to open a video application; three short press to open a flashlight application; a long press to open a telephone application.

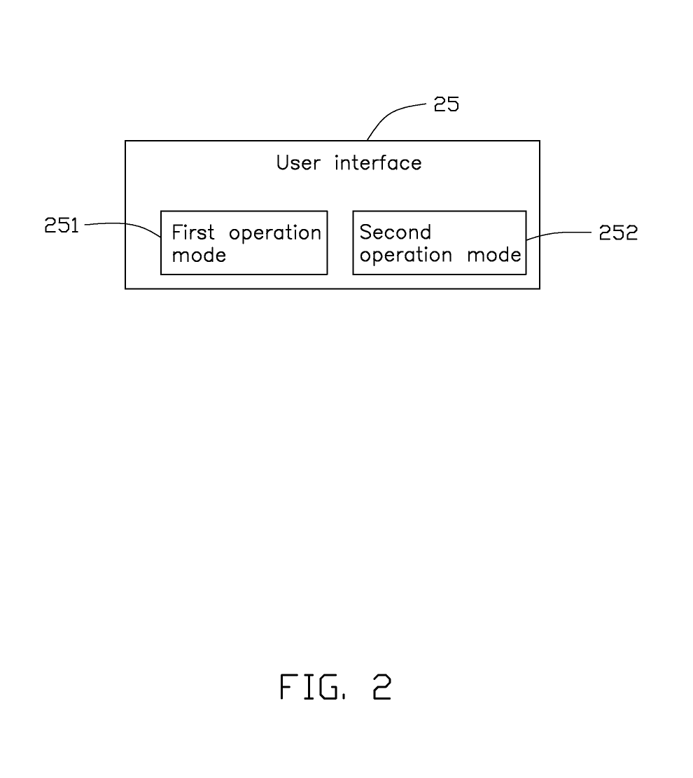

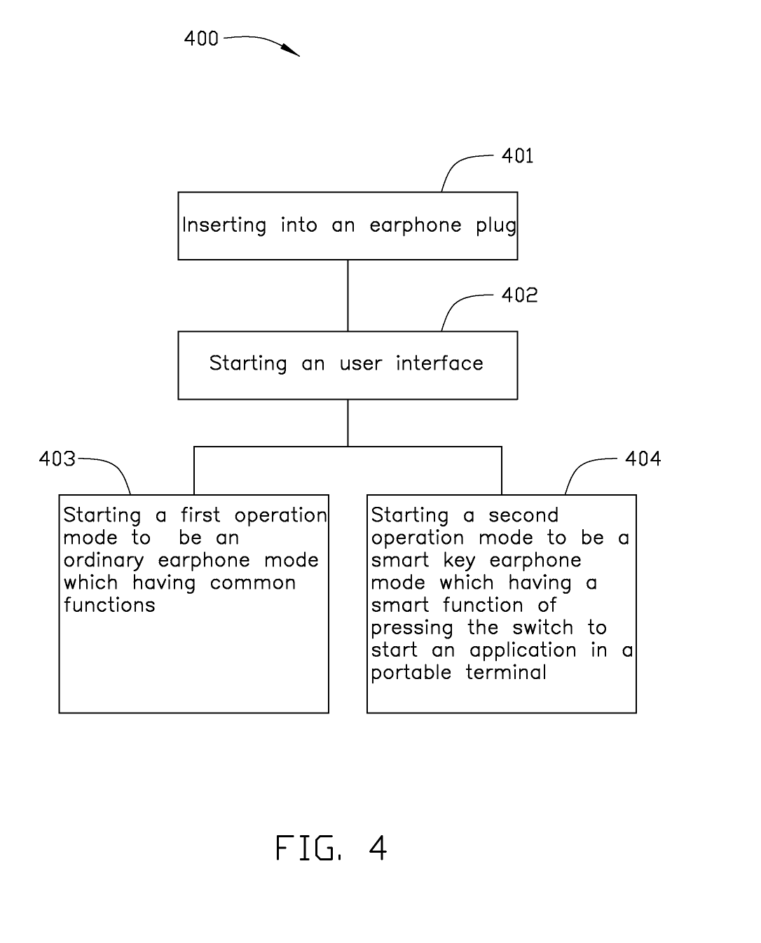

Referring to FIG. 1 and FIG. 4, when the earphone device 100 is inserted into the earphone jack 21, the earphone device 100 urges the elastic piece 221 to couple the elastic piece 221 with the first coupling end 222 and the second coupling end 223. Therefore, the processing module 23 can detect a low level signal to inform that the earphone device 100 has been inserted into the earphone jack 21. The switch 16 is switched on, the power supply 15 is coupled to the first section 11 via the switch 16, and the second section 11 is coupled to the processing module 23 via the switching module 22. Thus, the processing module 23 can detect a high level signal from the power supply 15. The switch 16 is switched off, and the processing module 23 can detect a low level signal again. Therefore, the switch 16 is switched on/off, and the processing module 23 can detect the high level signal and the low level signal to start a user interface 25 (see FIG. 2). The user interface 25 comprises a first operation mode 251 and a second operation mode 252. When the first operation mode 251 is selected, the earphone device 100 starts to the first operation mode 251. The first operation mode 251 is an ordinary earphone mode which having common functions, such as answer calls or ring up, receive music, increase/reduce volume. When the second operation mode 252 is selected, the earphone device 100 starts to the second operation mode 252. The second operation mode 252 is a smart key earphone mode which having a smart function of pressing the switch 16 to start an application in the portable terminal 20.

When the second operation mode 252 is selected, the switch 16 is switched on, the power supply 15 is coupled to the first section 11 via the switch 16, and the second section 11 is coupled to the processing module 23 via the switching module 22. Thus, the processing module 23 can detect a high level signal from the power supply 15. The switch 16 is switched off, and the processing module 23 can detect a low level signal again. Therefore, the switch 16 is switched on/off, and the processing module 23 can detect the switching time between the high level signal and the low level signal.

Referring to FIG. 4, a flowchart is presented in accordance with an example embodiment which is being thus illustrated. The example method 400 is provided by way of example, as there are a variety of ways to carry out the method. The method 400 described below can be carried out using the configurations illustrated in FIGS. 1-3, for example, and various elements of these figures are referenced in explaining example method 400. Each block shown in FIG. 4 represents one or more processes, methods or subroutines, carried out in the exemplary method 400. Additionally, the illustrated order of blocks is by example only and the order of the blocks can change according to the present disclosure. The exemplary method 400 can begin at block 401.

In use, the earphone device 10 is inserted into the earphone jack 21 (block 401). The switch 16 is switched on/off, the processing module 23 detects the high level signal and the low level signal to start the user interface 25 (block 402). When the first operation mode 251 is selected, the earphone device 100 starts to the first operation mode 251 (block 403). The first operation mode 251 is an ordinary earphone mode which having common functions, such as answer calls or ring up, receive music, increase/reduce volume. When the second operation mode 252 is selected, the earphone device 100 starts to the second operation mode 252 (block 404). The switch 16 is switched on/off, the processing module 23 detects the switching time between the high level signal and the low level signal and sends different signals to the receiving module 27. The receiving module 27 sends the different signals to the calling module 28 for allowing the calling module 28 to judge the operation of the switch 16 according to the different signals and call the corresponding application. The executing module 29 executes the corresponding application according to an indication of the calling module 28. For example, a short press to open a photograph application; two short press to open a video application; three short press to open a flashlight application; a long press to open a telephone application.

In general, the power supply 15 is added into the earphone device 100 for allowing the earphone device 100 to start anyone of the two operation modes. When the first operation mode 251 is selected, the earphone device 100 starts to the first operation mode 251. The first operation mode 251 is an ordinary earphone mode which having common functions, such as answer calls or ring up, receive music, increase/reduce volume. When the second operation mode 252 is selected, the earphone device 100 starts to the second operation mode 252. The second operation mode 252 is a smart key earphone mode which having a smart function of pressing the switch 16 to start an application in the portable terminal 20.

The embodiments shown and described above are only examples. Many details are often found in the art such as the other features of an earphone device 100. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An earphone device configured to engage an earphone jack of a portable terminal, the earphone device comprising:
an earphone plug comprising:
a first section and a second section;
a switch configured to be in one of an on position or an off position; and
a power supply having a first end and a second end opposite to the first end, the power supply coupled to the switch, the first end of the power supply coupled to one of the first section or the second section, and the second end of the power supply coupled to another of the first section or the second section,
wherein the earphone device is configured to send a first electronic signal to the portable terminal when the switch is in the on position, and send a second electronic signal to the portable terminal when the switch is in the off position, to allow the portable terminal to start one of at least two operation modes of the earphone device according to the first electronic signal and the second electronic signal.

2. The earphone device of claim 1, wherein the at least two operation modes comprises a first operation mode and a second operation mode, the first operation mode is an ordinary earphone mode which having common functions, and the second operation mode is a smart key earphone mode which having a smart function of pressing the switch to start an application in the portable terminal.

3. The earphone device of claim 2, wherein when the earphone device starts to the second operation mode, the earphone device is configured to send a third electronic signal to the portable terminal when the switch is switched on and send a fourth electronic signal to the portable terminal when the switch is switched off, for allowing the portable terminal to start the application according to the third electronic signal and the fourth electronic signal.

4. The earphone device of claim 3, wherein the first and third electronic signals are high level signal, and the second and fourth electronic signals are low level signal.

5. The earphone device of claim 1, wherein one of the two sections is a ground terminal of the earphone plug, and another of the two sections is a left channel of the earphone plug.

6. The earphone device of claim 1, wherein the earphone device is a line control earphone.

7. The earphone device of claim 1, wherein the switch is workable in each of at least two operation modes.

8. An electronic device assembly comprising:
a portable terminal comprising an earphone jack; and
an earphone device comprising an earphone plug, a power supply and a switch, the earphone plug engageable with the earphone jack, and the switch configured to be coupled with the power supply and the earphone plug,
wherein the switch is configurable to one of an on position or an off position such that an electronic signal from the earphone device to the portable terminal is changeable by the switch being in one of the on position or the off position, such that the portable terminal is configured to start one of at least two operation modes of the earphone device.

9. The electronic device assembly of claim 8, wherein the at least two operation modes comprises a first operation mode and a second operation mode, the first operation mode is an ordinary earphone mode which having common functions, and the second operation mode is a smart key earphone mode which having a smart function of pressing the switch to start an application in the portable terminal.

10. The electronic device assembly of claim 8, wherein the earphone plug comprises two sections, a first end of the power supply coupled with one of the two sections, and a second opposite end of the power supply coupled with another of the two sections.

11. The electronic device assembly of claim 10, wherein one of the two sections is a ground terminal of the earphone plug, and another of the two sections is a left channel of the earphone plug.

12. The electronic device assembly of claim 8, wherein the earphone device is a line control earphone.

13. The electronic device assembly of claim 8, wherein the switch is workable in each of at least two operation modes.

14. A control method of an electronic device assembly comprising:
an earphone device inserting into an earphone plug of a portable terminal;
sending a first electronic signal to the portable terminal by the earphone device when a switch is switched on, and sending a second electronic signal to the portable terminal by the earphone device when the switch is switched off; and
detecting the first electronic signal and the second electronic signal by the portable terminal to start one of at least two operation modes of the earphone.

15. The control method of claim 14, wherein the control method further comprising: starting the earphone device to be a first operation mode or a second operation mode, the first operation mode is an ordinary earphone mode which having common functions, and the second operation mode is a smart key earphone mode which having a smart function of pressing the switch to start an application in the portable terminal.

16. The control method of claim 14, wherein the control method further comprising: when the earphone device starts to the second operation mode, sending a third electronic signal to the portable terminal when the switch is switched on and sending a fourth electronic signal to the portable terminal when the switch is switched off, and starting the application according to the third electronic signal and the fourth electronic signal.

17. The control method of claim 16, wherein the third electronic signal is a high level signal, and the fourth electronic signals is a low level signal.

18. The control method of claim 14, wherein the first electronic signal is a high level signal, and the second electronic signals is a low level signal.

19. The control method of claim 14, wherein the earphone device is a line control earphone.

20. The control method of claim 14, wherein the switch is workable in each of at least two operation modes.
